(19) United States
(12) Patent Application Publication
(10) Pub. No.: US 2013/0196228 A1
(43) Pub. Date: Aug. 1, 2013

(54) BATTERY

(71) Applicant: MITSUBISHI HEAVY INDUSTRIES, LTD., Tokyo (JP)

(72) Inventor: Masanori Kogure, Tokyo (JP)

(73) Assignee: MITSUBISHI HEAVY INDUSTRIES, LTD., Tokyo (JP)

(21) Appl. No.: 13/742,559

(22) Filed: Jan. 16, 2013

(30) Foreign Application Priority Data
Jan. 31, 2012 (JP) 2012-017869

(51) Int. Cl. H01M 2/34

(52) U.S. Cl. CPC H01M 2/34
USPC 429/211

(57) ABSTRACT

A battery includes an electrode plate, an electrode terminal that has a curved end face, and a connecting portion that electrically connects the electrode plate and the curved end face and that is physically connected to the curved end face along the shape of the curved end face.

### BACKGROUND OF THE INVENTION

1. Field of the Invention

The present invention relates to a battery, and more particularly, to a battery with improved battery performance and safety.

Priority is claimed on Japanese Patent Application No. 2012-017869, filed on Jan. 31, 2012, the content of which is incorporated herein by reference.

2. Description of Related Art

Batteries can be classified into primary batteries which can only be discharged and secondary batteries which can be discharged and charged. These batteries have a structure in which an electrode assembly having electrode plates, that is, a positive electrode plate and a negative electrode plate, stacked with a separator interposed therebetween is enclosed in a battery case, and are generally used to supply power for driving an electric load such as a motor in a battery system.

The positive electrode plate or the negative electrode plate, that is, the electrode plate, is electrically connected and fixed to an electrode terminal formed in the battery case through riveting or laser welding inside the battery case (see Japanese Unexamined Patent Application, First Publication No. 2001-160387 and Japanese Unexamined Patent Application, First Publication No. 2006-324178).

### SUMMARY OF THE INVENTION

However, in the batteries described in Japanese Unexamined Patent Application, First Publication No. 2001-160387 and Japanese Unexamined Patent Application, First Publication No. 2006-324178, a plate-like lead electrically connected to an electrode plate is connected to an electrode terminal. The lead has a structure which is a plate-like shape and which is flexible at any position between the electrode terminal and the electrode plate. Accordingly, when vibration is applied to a battery such as when the battery is mounted on a moving object such as a vehicle, the electrode assembly may move vertically inside the battery case relative to the battery case and thus the lead may be significantly bent. When the lead is significantly bent, the lead may electrically connect the positive electrode plate and the negative electrode plate inside the battery case. Alternatively, when the battery case is made of metal, the lead may come in contact with the battery case and may electrically connect the positive electrode plate and the negative electrode plate to each other with the battery case interposed therebetween. When the positive electrode plate and the negative electrode plate are short-circuited, the battery performance and the safety of the battery may degrade.

Therefore, an object of the invention is to provide a battery with improved battery performance and safety by solving the above-mentioned problems with a simple configuration.

According to an aspect of the invention, there is provided a battery including: an electrode plate; an electrode terminal that has a curved end face; and a connecting portion that electrically connects the electrode plate and the curved end face and that is physically connected to the curved end face along the shape of the curved end face of the electrode terminal.

According to this configuration, since the connecting portion such as a lead is curved along the shape of the curved end face of the electrode terminal, it is possible to enhance resistance of the connecting portion to deformation. Accordingly, it is possible to prevent the bending of the connecting portion due to vibration.

In the battery according to the aspect of the invention, since at least part of the connecting portion such as a lead is configured not to be easily bent, it is possible to prevent short-circuiting and to provide a battery with improved battery performance and safety.

### BRIEF DESCRIPTION OF THE DRAWINGS

FIG. 1A and FIG. 1B are a diagram schematically illustrating a battery according to an embodiment of the invention, where FIG. 1A is a perspective view of the battery when seen in the +Y direction from the XZ plane and FIG. 1B is a YZ cross-sectional view taken along line A-A′ of FIG. 1A.

FIG. 2A and FIG. 2B are a diagram schematically illustrating an electrode plate used in the battery according to the embodiment of the invention, where FIG. 2A is a schematic diagram of a positive electrode plate and FIG. 2B is a schematic diagram of a negative electrode plate.

FIGS. 3A to 3D are a diagram schematically illustrating the configuration of a cover used in the battery according to the embodiment of the invention and the laser welding of a connecting portion (for example, a lead) to the cover, where FIG. 3A is a schematic diagram of the cover when seen from the XZ plane, FIG. 3B is a schematic diagram of the cover when seen in the +Z direction from the XY plane, FIG. 3C is a schematic diagram of a laser welding machine at a position of a cross-section of the cover taken along line B-B′ of FIG. 3B, and FIG. 3D is a schematic diagram illustrating a pressing point of an arm.

FIG. 4 is a perspective view of a connecting portion (for example, a lead) used in the battery according to the embodiment of the invention.

FIGS. 5A to 5C are a diagram schematically illustrating a modified example of the cover used in the battery according to the embodiment of the invention, where FIG. 5A is a schematic diagram of the cover when seen from the XZ plane, FIG. 5B is a schematic diagram of the cover when seen in the +Z direction from the XY plane, and FIG. 5C is a schematic diagram of the cover when seen from the YZ plane.

### DETAILED DESCRIPTION OF THE INVENTION

In a battery according to the invention, an electrode terminal includes a curved end face, and one end of a connecting portion (for example, a lead) electrically connecting an electrode plate to the end face is curved along and fixed to the curved end face. Hereinafter, a battery according to an embodiment of the invention will be described in detail with reference to the accompanying drawings.

Either a primary battery or a secondary battery can be used as the battery according to this embodiment, but it is assumed that a rechargeable battery such as a lithium ion secondary battery is used as a storage battery, as an example of the battery.

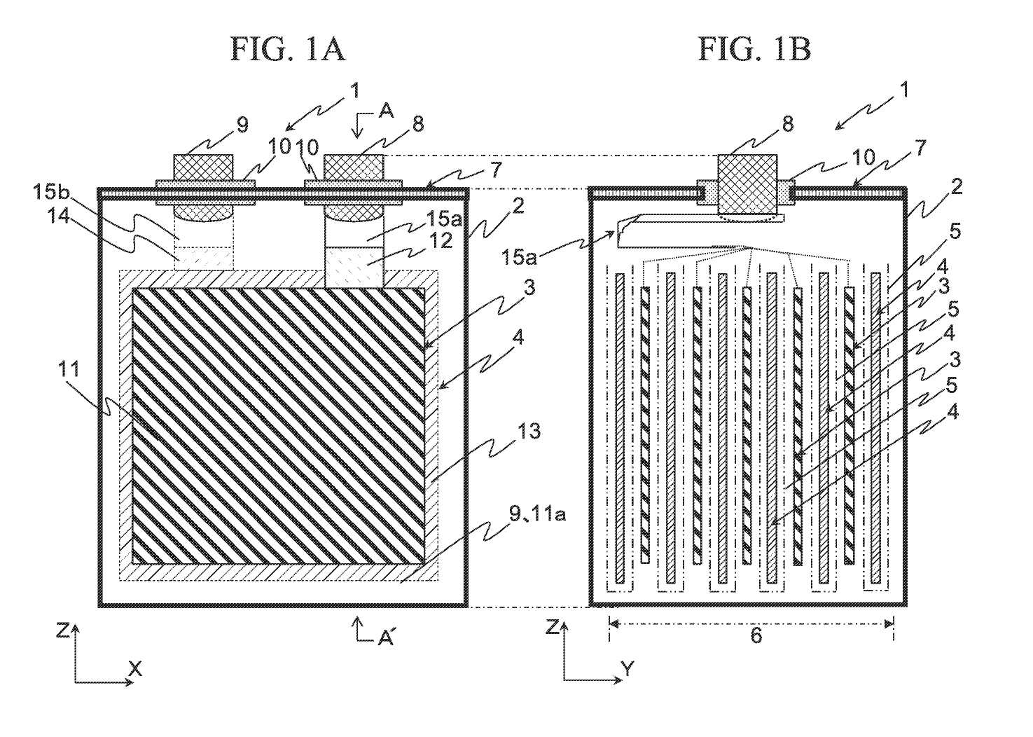

A battery 1 according to this embodiment will be described below with reference to the accompanying drawings. FIG. 1A is a perspective view of the battery when seen in the +Y direction from the XZ plane and FIG. 1B is an YZ cross-sectional view taken along line A-A′ of FIG. 1A.

In the drawings mentioned below, the same XYZ orthogonal coordinate system is used. FIG 1A is a schematic diagram for promoting understanding and thus all elements shown in FIG. 1B are not shown therein.

First, the battery 1 includes a square-like conductive (formed of metal such as aluminum) case body 2 having a substantially rectangular bottom surface on the XY plane and a wall surface extending in the +Z direction from all the sides of the substantially rectangular shape, an electrode assembly 6 that is received in the case body 2 and in which a positive electrode plate 3 and a negative electrode plate 4 are stacked with a separator 5 interposed therebetween, and a cover 7 that air-tightly encloses the case body 2 after receiving the electrode assembly 6 in the case body 2 (where the case body 2 and the cover 7 are air-tightly sealed by using laser welding to form a “battery case”). Although not shown in the drawing, an electrolytic solution or an electrolyte may be stored in the battery case.

In the cover 7, an electrode terminal (that is, a positive electrode terminal 8 and a negative electrode terminal 9) disposed to penetrate the cover 7 and to protrude from both surfaces of the cover 7 and an insulating resin 10 (an insulator such as a plastic resin) fixing the electrode terminal to the cover 7 and electrically insulating the electrode terminal and the cover 7 from each other are formed. Part of the cover 7 other than the electrode terminal and the resin 10 is formed of the same conductive material as the case body 2. The electrode terminal is formed in a cylindrical shape. The electrode terminal is not limited to the cylindrical shape but may have a polygonal columnar shape such as a quadrangular columnar shape.

The end face of the electrode terminal inside the battery case is an end face to be welded and fixed to a connecting portion 15 and is also an end face electrically connecting the electrode terminal and the electrode plate. As described later, the end face has a curved shape and the connecting portion 15 such as lead is fixed to the curved end face through laser welding.

The electrode assembly 6 will be described below, for example, as a stacked electrode assembly in which multiple electrode plates 3 and multiple negative electrode plates 4 are sequentially stacked with a separator 5 interposed therebetween. A positive electrode plate 3 is formed by coating both surfaces of a positive-electrode metal foil of aluminum or the like (hereinafter, also referred to as a “positive electrode substrate”) with a positive-electrode active material such as lithium manganate and then punching the resultant. The positive electrode plate 3 includes a substantially rectangular part (hereinafter, referred to as a “positive electrode coating part” 11) in which the positive electrode substrate is coated with the positive-electrode active material and a substantially rectangular part (hereinafter, referred to as a “positive electrode tab” 12) in which the positive electrode substrate is not coated with the positive-electrode active material. The positive electrode tab 12 is connected to a side located in the +Z direction out of two sides which are longitudinal in the X direction of the positive electrode coating part 11.

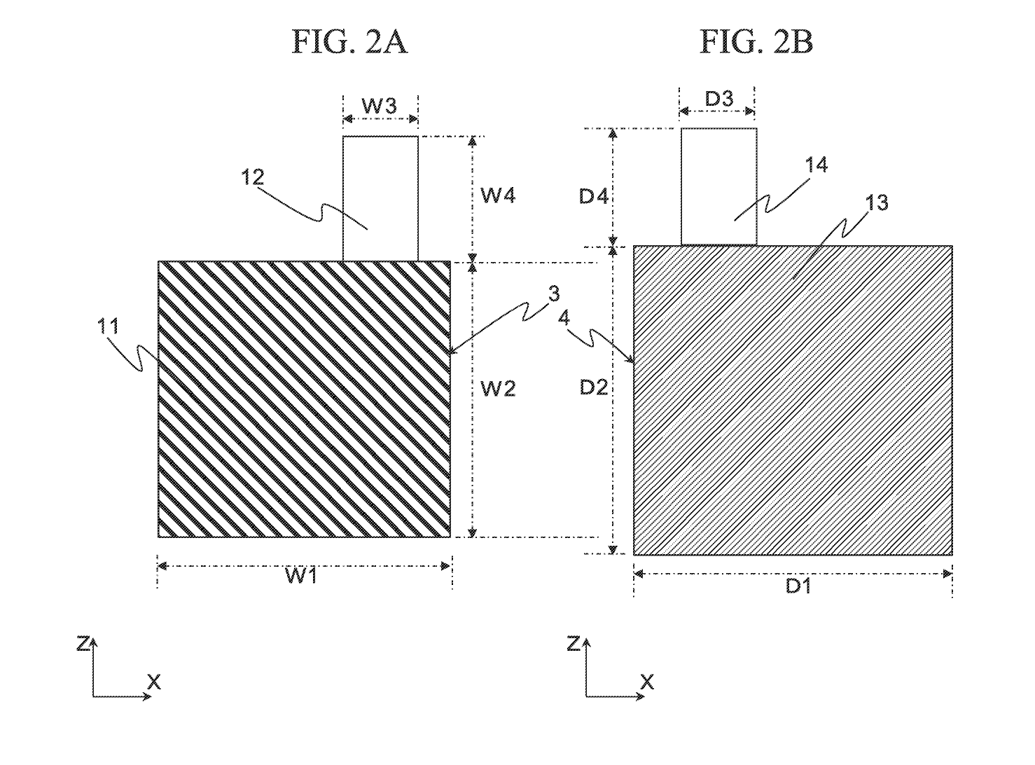

The connection relationship between the positive electrode coating part 11 and the positive electrode tab 12 is as shown in FIG. 2A.

That is, the positive electrode coating part 11 has a substantially rectangular shape with a size “W1” in the X direction and a size “W2” in the Z direction. The positive electrode tab 12 has a substantially rectangular shape with a size “W3” in the X direction and a size “W4” in the Z direction. When a virtual line (hereinafter, referred to as a “positive-electrode virtual line”) is drawn in the Z direction from the center of the width in the X direction of the positive electrode coating part 11, the positive electrode tab 12 is located further in the +X direction than the positive electrode virtual line, is located inside in the X direction of the positive electrode coating part 11, and is connected to the positive electrode coating part 11 to form a body. Accordingly, 0<W3<((W1)÷2) is satisfied.

A negative electrode plate 4 is formed by coating both surfaces of a negative-electrode metal foil made of copper or the like (hereinafter, also referred to as a “negative electrode substrate”) with a negative-electrode active material such as carbon and then punching the resultant. The negative electrode plate 4 includes a substantially rectangular part (hereinafter, referred to as a “negative electrode coating part” 13) in which the negative electrode substrate is coated with the negative-electrode active material and a substantially rectangular part (hereinafter, referred to as a “negative electrode tab” 14) in which the negative electrode substrate is not coated with the negative-electrode active material. The negative electrode tab 14 is connected to a side located in the +Z direction selected from two sides which are longitudinal in the X direction of the negative electrode coating part 13. The connection relationship between the negative electrode coating part 13 and the negative electrode tab 14 is as shown in FIG. 2B.

That is, the negative electrode coating part 13 has a substantially rectangular shape with a size “D1” in the X direction and a size “D2” in the Z direction. The negative electrode tab 14 has a substantially rectangular shape with a size “D3” in the X direction and a size “D4” in the Z direction. When a virtual line (hereinafter, referred to as a “negative-electrode virtual line”) is drawn in the Z direction from the center of the width in the X direction of the negative electrode coating part 13, the negative electrode tab 14 is located further in the +X direction than the negative electrode virtual line, is located inside in the X direction of the negative electrode coating part 13, and is connected to the negative electrode coating part 13 to form a body. Accordingly, 0<D3<((D1)÷2) is satisfied.

The size of the substantially rectangular shape in the XZ plane of the negative electrode coating part 13 is smaller than the size with which it is received in the battery case without being bent, that is, the inner diameter on the XZ plane of the battery case. The size of the substantially rectangular shape on the XZ plane of the negative electrode coating part 13 is larger than the size of the substantially rectangular shape on the XZ plane of the positive electrode coating part 11. That is, 0<W1<D1 and 0<W2<D2 are satisfied.

Therefore, as shown in FIG. 1A, the positive electrode coating part 11 is disposed in the plane of the negative electrode coating part 13 when seen from the Y direction. Since the positive-electrode virtual line and the negative-electrode virtual line are substantially matched on the XZ plane and the positive electrode plate 3 and the negative electrode plate 4 are sequentially stacked in the Y direction with the separator interposed therebetween, the negative electrode tab 14 is located at a position not overlapping with the positive electrode tab 12 on the XZ plane.

The separator 5 is a bag-like separator in this embodiment, as shown in FIG. 1B. Here, a state where the overall surface of the coating part of the electrode plate (here, the overall surface of the negative electrode coating part 13) is received in the bag-like separator and the electrode tab (here, the negative electrode tab 14 out of the positive electrode tab 12 and the negative electrode tab 14) protrudes from the inside to the outside is referred to as an “inclusion state”.

By forming the separator 5 in a bag shape, it is possible to satisfactorily prevent the contact of the negative electrode plate 4 with the positive electrode plate 3. When such a contact prevention function can be achieved by adjusting the size or the like of the separator, the separator is not limited to the bag shape. That is, the separator may have simply a substantially rectangular sheet shape.

The negative electrode plate 4 included in the bag-like separator 5 is first stacked, the positive electrode plate 3 is stacked on the separator 5 of the negative electrode plate 4, and then another negative electrode plate 4 included in the bag-like separator 5 on the positive electrode plate 3 (that is, in the +Y direction). At this time, the stacked negative electrodes plates 4 are aligned with each other on the XZ plane of the respective negative electrode tabs 14. The stacked positive electrode plates 3 are aligned with each other on the XZ plane of the respective positive electrode tab 12.

By repeating this stacking, an electrode assembly 6 which includes multiple positive electrode plates 3 and multiple negative electrode plates 4 and in which the negative electrode plate 4 is disposed on both ends in the Y direction when seen in the X direction is finally formed (see FIG. 1B). In the electrode assembly 6, the positive electrode plates 3 and the negative electrode plates 4 are appropriately fixed with an insulating tape not shown without misalignment in position.

The curved end face of an electrode terminal (hereinafter, referred to as a “curved end face”) and the corresponding electrode tab are physically connected to each other with the conductive connecting portion 15 (that is, a positive-electrode connecting portion 15a or a negative-electrode connecting portion 15b) so that electrically connect the electrode terminal and the electrode tab which have the same polarity (that is, positive polarity or negative polarity). Specifically, a rectangular positive-electrode connecting portion 15a formed of the same metal as the positive electrode substrate and a rectangular negative-electrode connecting portion 15b formed of the same metal as the negative electrode substrate are used as the connecting portion 15. Here, it is assumed that the width of the positive-electrode connecting portion 15a is W3, the width of the negative-electrode connecting portion 15b is D3, and these connecting portions 15 are leads.

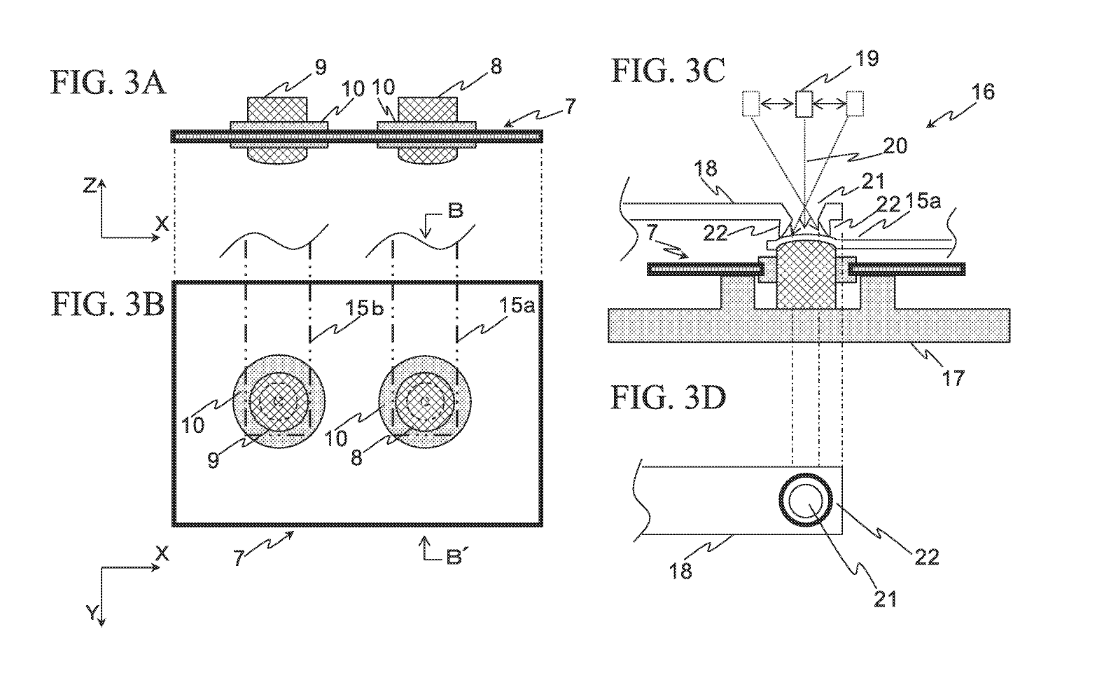

The curved end face of the electrode terminal is not planar but curved and is a shape having a curved surface of a convex lens shape in which the central portion is thicker than the edge. The rear surface (that is, the surface to be located inside the battery case) of the cover 7 is shown in FIG. 3B. As contour lines of the electrode terminals 8 and 9 are indicated by dotted lines, the curved end face of the electrode terminal of the battery 1 has a shape (hereinafter, referred to as a “convex lens shape”) in which the central portion of the curved end face is higher than any other edge of the curved end face and a slow curve is drawn to be convex from the central portion to the edge.

When the connecting portion 15 is fixed to the electrode terminal through laser welding, the positive-electrode connecting portion 15a and the negative-electrode connecting portion 15b are located at the positions indicated by two-dot chained lines with respect to the cover 7.

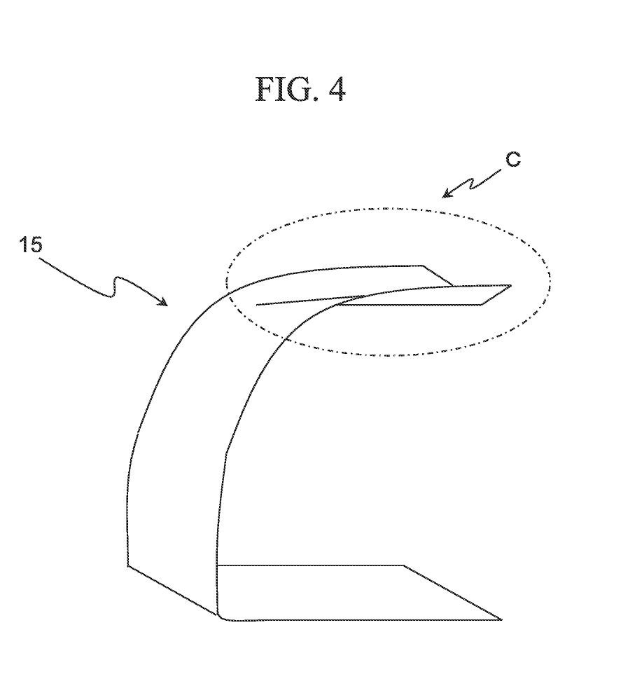

Since the connecting portion 15 is welded along the curved end face of the electrode terminal, the part of the connecting portion 15 physically connected to the curved end face has a shape which is curved in a U shape along the shape of the curved end face. FIG. 4 shows only the connecting portion 15 extracted from the battery 1. The part which is indicated by the one-dot chained line C is (hereinafter, referred to as a “curved portion”) curved and deformed in a U shape. The other part of the connecting portion 15 has a substantially flat shape and is curved in a U shape for physical connection to the corresponding electrode tab through laser welding.

The flat plate-like part (hereinafter, referred to as a “flat part”) of the connecting portion 15 can be easily bent when vibration is applied to the battery 1. However, since the curved part of the connecting portion 15 is curved in a U shape, the shape is fixed and is not bent well.

Specifically, a curved part is formed in a linear part which is one of two linear parts of the “U” shape of the connecting portion 15 curved in the U shape and which is connected to the electrode terminal. In a cross-section perpendicular to the length direction of the linear part, since the curved part is bent in a U shape, the curved part has a larger resistance to deformation than the flat part and the linear part is not deformed well as a result.

Accordingly, when the vibration is applied to the battery 1, the bending like the flat part is not caused in the linear part and it is thus possible to reduce the possibility in which the connecting portion 15 comes in contact with the battery case. As described above, one end of the connecting portion 15 is welded to the curved end face and the other end of the connecting portion 15 is fixed to the electrode tab through laser welding or the like. At this time, in the positional relationship between part of the electrode tap subjected to the welding and part of the connection portion 15 subjected to the welding, the parts are disposed in the battery 1 so that the part of the connecting portion 15 is located lower (that is, further in the −Z direction) than the part of the electrode tab. Accordingly, it is possible to prevent the electrode plate from being damaged due to the contact of the end of the electrode tab with the electrode plate or the like.

The laser welding of the connecting portion 15 to the curved end face of the electrode terminal is carried out as follows.

FIG. 3C is a schematic diagram illustrating a state where the cover 7 used in the battery 1 is fixed to the laser welding machine 16 to perform a laser welding operation and is specifically a schematic diagram of the laser welding machine 16 at a position on the cross-section of the cover 7 taken along line B-B′ of FIG. 3B. The laser welding machine 16 includes a table 17 supporting the cover 7 to be substantially in parallel, a plate-like arm 18 including a through-hole 21 and a protruding edge 22, which has a shape similar to the through-hole, around the through-hole, and a laser device 19 irradiating the through-hole with a laser beam 20.

First, the cover 7 having the electrode terminals and the like is disposed on the table 17 so that the rear surface of the cover 7 faces the upside. Convex portions are appropriately formed on the table 17 and the cover 7 is supported by the convex portions to be substantially in parallel. Then, the connecting portion 15 is appropriately disposed on the curved end face of the electrode terminal so as to have the arrangement shown in FIG. 3B. The protruding edge 22 formed in the arm 18 and the disposed connecting portion 15 are pressed against the curved end face.

The protruding edge 22 is disposed to apply a pressure to the plane of the curved end face via the connecting portion 15. The protrusion of the protruding edge 22 is inclined from the center to the edge so that the protruding edge 22 can apply a partial pressure of the applied pressure in the direction from the center of the curved end face to the edge. Here, as shown in FIG. 3D which is a schematic diagram of the surface (that is, the rear surface of the arm 18) facing the cover 7 out of the surfaces of the arm 18, the circular protruding edge 22 is formed around the circular through-hole 21 formed in the arm 18.

The position at which the protrusion applies the pressure to the connecting portion 15 is a pressing point of the arm 18. The height of the protrusion from the arm 18 is set to be equal at any position of the protruding edge 22 so that the pressure is equal at any position of the protruding edge 22. The arm 18 and the protruding edge 22 are formed of a metal having a higher melting point than that of the connecting portion 15 which is a welding target or a heat-resistance material (such as ceramic). The protruding edge 22 may be initially formed as a body with the other part of the arm 18 or may be formed separately therefrom and then be fixed.

When the connecting portion 15 is pressed against the curved end face of the electrode terminal by the protruding portion 22 of the arm 18, the end face of the electrode terminal is originally not a plane but a curved end face and thus a partial pressure spreading from the center of the curved end face to the overall circumferential edge is given to the connecting portion 15. As described above, since the shape of the protruding edge 22 has a shape further enhancing the partial pressure, the partial pressure more strongly spreading from the center of the curved end face to the overall edge is given to the connecting portion 15.

Therefore, the connecting portion 15 can come in clear contact with the overall surface of the curved end face of the electrode terminal.

Thereafter, as shown in FIG. 3C, a laser beam 20 is emitted from the laser device 19 to the through-hole 21 of the arm 18 to weld the connecting portion 15 to the curved end face of the electrode terminal. As indicated by two solid arrows in FIG. 3C, the laser beam 20 is incident on a wide range of the connecting portion 15 via the through-hole 21 by appropriately adjusting the position of the laser device 19 or the output angle of the laser beam 20, thereby welding the range.

At this time, since the protruding edge 22 is disposed to cover the circumference of the connecting portion 15 to be welded, it is possible to prevent the influence of the reflected beam of the laser beam coming in contact with the connecting portion 15. That is, it is possible to prevent a problem in which other members are melted because the reflected beam leaks between the protruding edge 22 and the connecting portion 15 comes in contact with the other members of the laser device 19.

When the end face of the electrode terminal to which the connecting portion 15 is welded is a plane as in the related art, the connecting portion 15 may be separated from the end face or may not come in contact with the end face completely at the time of welding the connecting portion 15 through the laser welding, and thus it may not be easy to reliably fix the connecting portion 15 to the electrode terminal.

However, according to the above-mentioned laser welding machine 16, since the connecting portion 15 comes in spreading contact with the curved end face of the electrode terminal, the connecting portion 15 substantially comes in clear contact with the curved end face. Accordingly, it is possible to reliably fix the connecting portion 15 to the electrode terminal.

As described above, in the battery 1 according to this embodiment, since the electrode terminal has a curved end face and the connecting portion 15 is welded to the curved end face, the connecting portion 15 has a linear part having a curved part and it is thus possible to prevent the connecting portion 15 from coming in contact with the battery case.

Since the electrode terminal has the curved end face, it is possible to more reliably fix the connecting portion 15 to the electrode terminal when welding the connecting portion 15 to the curved end face through laser welding or the like.

Although it is stated above that the connecting portion 15 is a lead, the connecting portion 15 may be an electrode tab. In this case, the electrode tab is directly welded to the curved end face of the electrode terminal.

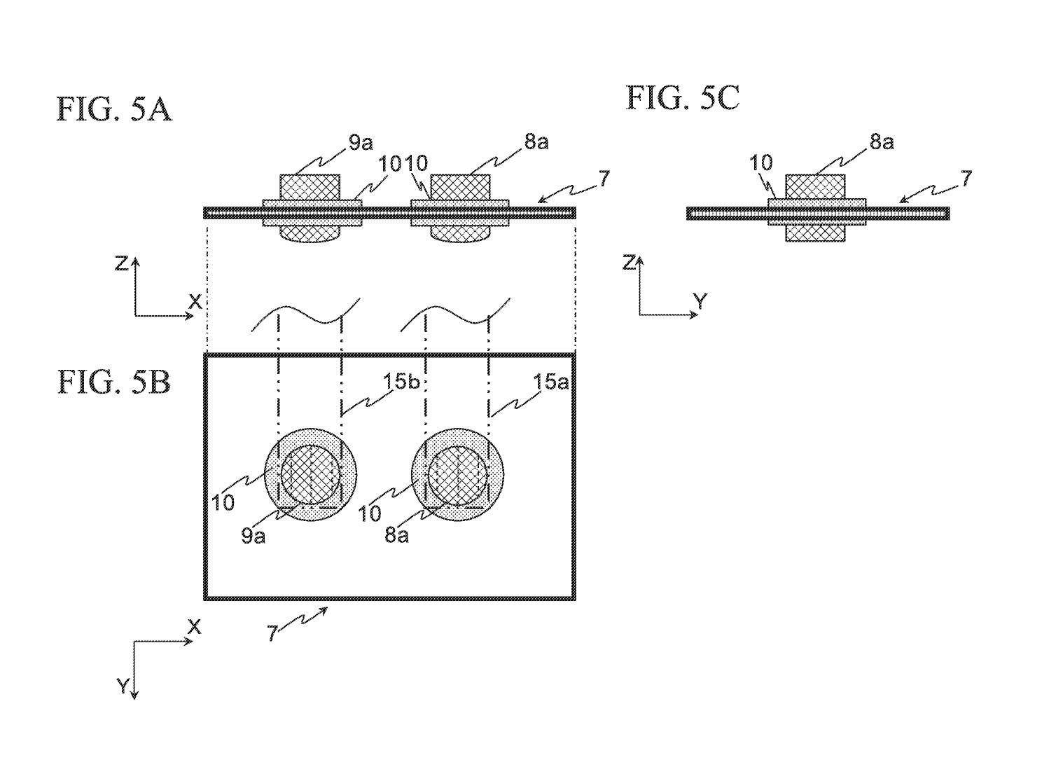

The curved end face of the electrode terminal is not limited to the above-mentioned convex lens shape, but may have a semi-cylindrical shape as shown in FIGS. 5A to 5C. The rear surface of the cover 7 in this case is shown in FIG. 5B. As contour lines are indicated by dotted lines in the electrode terminals 8 and 9, the curved end face of the electrode terminal of the battery 1 has a shape protruding like a mountain from both edges in the X direction of the curved end face to the center of the curved end face. Since it has a semi-cylindrical shape, the curved end face does not look like a mountain, unlike the convex lens shape shown in FIG. 4, when the cover is seen from the X direction (see FIG. 5C). By matching the length direction of the connecting portion 15 with the direction of the contour line indicating the central part which is the summit of the mountain, the above-mentioned advantages can be achieved even when the curved end face has a semi-cylindrical shape.

The invention is not limited to the above-mentioned embodiment, modified examples thereof, or combinations thereof, but may be modified in various forms without departing from the concept of the invention. For example, the battery case has a square shape, but may have a cylindrical shape. Similarly, the electrode assembly 6 may be an electrode assembly (stacked electrode assembly) in which multiple positive electrode plates and multiple negative electrode plates are sequentially stacked with a separator interposed therebetween, or may be an electrode assembly (wound electrode assembly) in which one positive electrode plate and one negative electrode plate are stacked with a separator interposed therebetween and which is wound. When the electrode assembly 6 is a stacked electrode assembly, the number of positive electrode plates 7 and the number of negative electrode plates 12 may be appropriately designed to one or more.

What is claimed is:

1. A battery comprising:
an electrode plate;
an electrode terminal that has a curved end face; and
a connecting portion that electrically connects the electrode plate and the curved end face and that is physically connected to the curved end face along the shape of the curved end face.

2. The battery according to claim 1, wherein the connecting portion is physically connected to the curved end face while being deformed along the shape of the curved end face.

3. The battery according to claim 2, wherein the curved end face has a convex lens shape.

4. The battery according to claim 2, wherein the curved end face has a semi-cylindrical shape.

5. The battery according to claim 3, wherein the connecting portion is a lead.

6. The battery according to claim 3, wherein the connecting portion is an electrode tab formed in the electrode plate.

7. The battery according to claim 4, wherein the connecting portion is a lead.

8. The battery according to claim 4, wherein the connecting portion is an electrode tab formed in the electrode plate.
